(19) United States
(12) Patent Application Publication
(10) Pub. No.: US 2021/0184523 A1
(43) Pub. Date: Jun. 17, 2021

(54) ROTOR FOR AN ELECTRICAL MACHINE, HAVING ASYMMETRICAL POLES

(71) Applicant: IFP Energies nouvelles, RUEIL-MALMAISON (FR)

(72) Inventors: Thomas VALIN, RUEIL-MALMAISON (FR); Benjamin GAUSSENS, RUEIL-MALMAISON (FR); Baptiste CHAREYRON, RUEIL-MALMAISON (FR); Abdenour ABDELLI, RUEIL-MALMAISON (FR)

(21) Appl. No.: 17/263,096

(22) PCT Filed: Jul. 1, 2019
(86) PCT No.: PCT/EP2019/067558

§ 371 Date: Jan. 25, 2021

(30) Foreign Application Priority Data
Mar. 24, 2018 (FR) 1856866
Mar. 28, 2019 (FR) 1903274

(51) Int. Cl. H02K 1/27; H02K 21/14

(52) U.S. Cl. CPC H02K 1/2766; H02K 29/03; H02K 21/14

(57) ABSTRACT

The present invention relates to a rotor (1) for an electrical machine having N primary magnetic poles (13) and N secondary magnetic poles (14). the poles are flux barriers having opening angles (θ1, θ2, θ3) for the poles to be asymmetrical. The invention further relates to an electrical machine comprising such a rotor.

### CROSS-REFERENCE TO RELATED APPLICATIONS

This application is a National Stage Application of PCT/EP2019/067558, filed Jul. 1, 2019, which claims priority to French Patent Application No. 19/03.274, filed Mar. 28, 2019, and French Patent Application No. 18/56.866, filed Jul. 24, 2018, the contents of which are incorporated herein by reference in their entirety.

### BACKGROUND OF THE INVENTION

### Field of the Invention

The present invention relates to a synchro-reluctant (permanent magnet-assisted) rotary electrical machine and more particularly concerns a rotor of such a machine operating with a low-voltage continuous bus and at a high rotational speed.

Generally, such an electrical machine comprises a stator and a rotor coaxially arranged in one another.

The rotor has a rotor body with a stack of metal sheets arranged on a rotor shaft. These sheets include housings for permanent magnets, and perforations for creating flux barriers allowing the magnetic flux of the magnets to be radially directed towards the stator and for promoting the generation of a reluctance torque.

This rotor is generally housed within a stator that carries electrical windings for generating a magnetic field enabling the rotor to be rotated.

### Description of the Prior Art

In patent application WO-2016/188,764, the rotor comprises axial recesses running throughout the sheets.

A first series of axial recesses, radially arranged one above the other and at a distance from one another, forms housings for magnetic flux generators, which have permanent magnets formed as rectangular bars.

The other series of recesses has perforations oriented in an inclined radial direction, starting from the housings and ending in a vicinity of the edge of the sheets, near to the air gap.

The inclined perforations are arranged symmetrically with respect to the magnet housings which form each time a substantially V-shaped flat-bottomed geometrical figure. The flat bottom is formed by the magnet housing and inclined arms of the V are formed by the perforations. Flux barriers are formed by the perforations. The magnetic flux from the magnets then only passes through the solid parts between the perforations. These solid parts are made of a ferromagnetic material.

However, it has been observed that the counter-electromotive force harmonics and the torque ripples are significant in this type of permanent magnet-assisted synchronous reluctance machine.

The harmonics and torque ripples may generate jolts and vibrations at the rotor, which causes discomfort in using this machine. The present invention is directed to overcoming the aforementioned drawbacks, and notably to reduce the torque ripple, the counter-electromotive force harmonics and the acoustic noise, while maximizing torque production.

### SUMMARY OF THE INVENTION

The present invention relates to a rotor for an electrical machine, the rotor comprising:
a rotor body, made up of stacked of metal sheets, which are preferably arranged on a rotor shaft,
N pairs of magnetic poles, each magnetic pole having at least three magnets positioned in axial recesses; and
three asymmetrical flux barriers in each magnetic pole, including an external flux barrier, a central flux barrier and an internal flux barrier, each flux barrier including two inclined recesses positioned on either side of each axial recess, the two inclined recesses forming an opening angle that corresponds to the angle between two lines each passing through center C of the rotor and through a midpoint positioned in the region of an outer face of the respective recesses of each flux barrier.

The rotor comprises:
N primary magnetic poles each having an internal flux barrier having an opening angle (θ1), a central flux barrier having an opening angle (θ2) and an external flux barrier having an opening angle (θ3), the opening angles (θ1, θ2, θ3) comply with at least two of the following three equations: θ1=(0.905+/0.027)×P, θ2=(0.683+/0.027)×P, θ3=(0.416+/0.027)×P;
N secondary magnetic poles each having of an internal flux barrier having an opening angle (θ1), a central flux barrier having an opening angle (θ2) and an external flux barrier having an opening angle (θ3), with the opening angles (θ1, θ2, θ3) complying with at least two of the following three equations: θ1=(0.819+/0.027)×P, 74 2=(0.601+/0.027)×P, θ3=(0.373+/0.027)×P, each secondary pole alternating with a primary pole; and
P is the pole pitch of the rotor defined in degrees by

$$P = \frac{360}{2 \times N} .$$

According to an embodiment of the invention, the number N of magnetic pole pairs ranges between 2 and 9, preferably between 3 and 6, and it is more preferably 4.

According to an implementation of the invention, the flux barriers are substantially V-shaped with a flat bottom.

According to an embodiment of the invention, the opening angles (θ1, θ2, θ3) of the primary magnetic poles check at least two of the following three equations: θ1=(0.905+/0.02)×P, θ2=(0.683+/0.02)×P, θ3=(0.416+/0.02)×P.

According to an embodiment of the invention, the opening angles (θ1, θ2, θ3) of the secondary magnetic poles complying with at least two of the following three equations: θ1=(0.819+/0.02)×P, θ2=(0.601+/0.02)×P, θ3=(0.373+/0.02)×P.

According to an embodiment, the opening angles (θ1, θ2, θ3) of the primary magnetic poles complying with the three equations.

According to an embodiment, the opening angles (θ1, θ2, θ3) of the secondary magnetic poles complying with the three equations.

The invention further relates to an electrical machine comprising a stator and a rotor according to any one of the above characteristics, with the rotor being housed inside the stator.

According to an embodiment, the stator comprises radial slots circumferentially arranged along the stator.

Advantageously, the slots extend axially along the stator.

According to an aspect, the stator has an outside diameter ranging between 100 and 300 mm, and preferably is 140 mm, and an inside diameter ranging between 50 and 200 mm, and it is preferably 95 mm.

According to a characteristic, it comprises an air gap of length ranging between 0.4 and 0.8 mm, which preferably is equal to 0.5 mm.

Advantageously, the electrical machine is synchro-reluctant electrical machine

### BRIEF DESCRIPTION OF THE FIGURES

Other features and advantages of the invention will be clear from reading the description hereafter of embodiments, given by way of non limitative example, with reference to the accompanying figures wherein:

FIG. 1 illustrates a rotor according to an embodiment of the invention comprising four pole pairs;

FIG. 2 illustrates an electrical machine with four pole pairs according to an embodiment of the invention;

FIG. 3 illustrates an electrical machine with three pole pairs according to an embodiment of the invention;

FIG. 4 is a curve showing the torque ripples as a function of the phase shift; and

FIG. 5 is a curve showing torque as a function of the phase shift.

### DETAILED DESCRIPTION OF THE INVENTION

The present invention relates to a rotor for an electrical machine, notably a synchro-reluctant electrical machine. Furthermore, the present invention relates to an electrical machine comprising a rotor according to the invention and a stator with the rotor being arranged inside of coaxially with the stator.

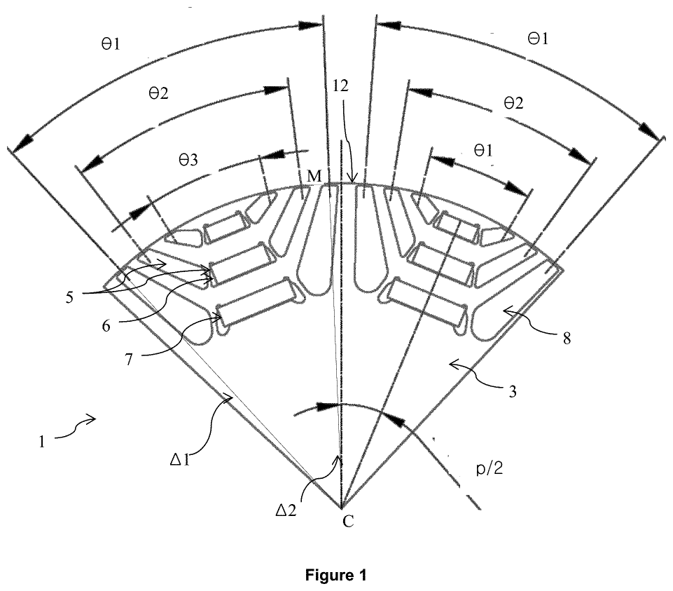

As illustrated in FIG. 1 (by way of non-limitative example), a rotor 1 comprises, in a manner known per se, a shaft (not shown), preferably magnetic, on which a stack of metal sheets 3 is arranged. Within the context of the invention, these sheets are ferromagnetic, flat, identical, rolled and of circular shape, and are assembled to one another by any known technique. Sheets 3 can comprise a central bore (not shown) traversed by the rotor shaft and an axial recesses 5 running throughout sheets 3.

A first series of axial recesses 6, which are radially arranged above one another and at a distance from one another, forms housings for magnetic flux generators which here are permanent magnets 7 formed as bars. Axial recesses 6 substantially form trapezia. However, axial recesses 6 can have other shapes, notably rectangular, square, etc.

A second series of recesses has perforations 8 which are inclined with respect to the radial direction, starting from axial recesses 6 and ending in a vicinity of the edge of sheets 3, which is in the region of an air gap of the electrical machine.

Inclined perforations 8 are arranged symmetrically with respect to recesses 6 of magnets 7 which each form a substantially V-shaped flat-bottomed geometrical figure. The flat bottom is formed by housing 6 of magnets 7 and the inclined arms of the V are formed by inclined perforations 8. Inclined perforations 8 form flux barriers. The magnetic flux from magnets 7 then can only pass through the solid parts of sheets 3 between the recesses. These solid parts are made of a ferromagnetic material.

According to the invention, the rotor comprises N pairs of magnetic poles (or 2×N magnetic poles). Each magnetic pole has three recesses 6 for the magnets in the same radial direction, and the associated flux barriers (9, 10, 11). Advantageously, N can range between 2 and 9, preferably N ranges between 3 and 6, and is preferably equal to 4.

A pole pitch P is defined from the number N of pole pairs. Expressed in degrees, the pole pitch can be determined with a formula of the type:

$$P = \frac{360}{2 \times N} .$$

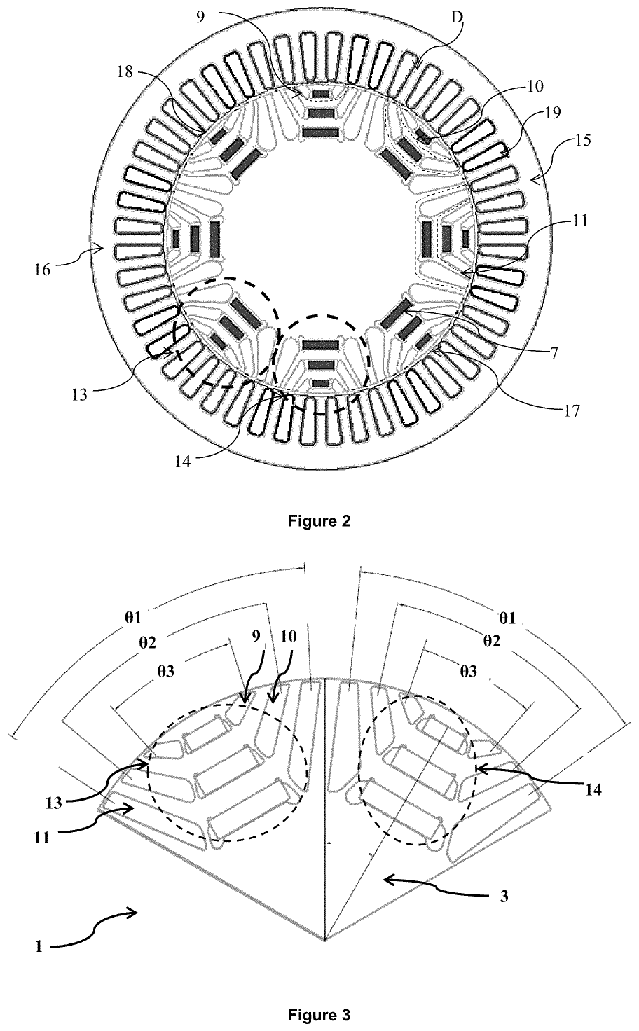

For the example illustrated in FIGS. 1 and 2, rotor 1 comprises eight magnetic poles (N=4) and therefore pole pitch P is 45°. Each magnetic pole has three permanent magnets 7 positioned in the three axial recesses 6 provided for housing permanent magnets 7. Rotor 1 is also made up of three flux barriers, including an external flux barrier 9 (associated with external recess 6, which is closest to the periphery of rotor 1), a central flux barrier 10 which is associated with central recess 6 and an internal flux barrier 11 which is associated with internal recess 6, that is closest to the center of rotor 1.

As can be seen in FIGS. 1 and 2, each flux barrier (9, 10, 11) comprises two inclined perforations symmetrically arranged with respect to the housings of magnets 7 for each magnetic pole. Thus, a substantially V-shaped flat-bottomed geometrical figure is formed, with the flat bottom formed by housing 7 and the inclined arms of this V formed by the inclined perforations. An opening angle (θ1, θ2, θ3) which qualifies the opening of the V shape corresponds to each flux barrier (9, 10, 11) of each magnetic pole. These opening angles correspond to the angle between two lines (Δ1, Δ2) passing each through the center C of rotor 1 and through a midpoint M positioned at an outer face 12 of perforations 8 of inclined radial direction of each flux barrier. This outer face 12 is on the periphery of rotor 1, in the region of a mechanical air gap of the electrical machine, as detailed in the description hereafter.

Within the context of the invention, rotor 1 comprises two distinct magnetic pole architectures. It therefore comprises N primary magnetic poles 13 and N secondary magnetic poles 14. The rotor comprises an alternation of primary magnetic poles 13 and secondary magnetic poles 14. For the examples of FIGS. 1 and 2, rotor 1 comprises four primary magnetic poles 13 and four secondary magnetic poles 14.

According to the invention, the N primary magnetic poles 13 each have an internal flux barrier 11 having an opening angle θ1 P, a central flux barrier 10 having an opening angle θ2 and an external flux barrier 9 having an opening angle θ3. The opening angles (θ1, θ2, θ3) of the primary magnetic poles satisfy at least two of the following three equations: θ1=(0.905+/0.027)×P, θ2=(0.683+/0.027)×P, θ3=(0.416+/0.027)×P. The N secondary magnetic poles 14 each have an internal flux barrier 11 having an opening angle θ1, a central flux barrier 10 having an opening angle θ2 P and an external flux barrier 9 having an opening angle θ3. The opening angles (θ1, θ2, θ3) of the secondary magnetic poles satisfy at least two of the following three equations: θ1=(0.819+/0.027)×P, θ2=(0.601+/0.027)×P, θ3=(0.373+/0.027)×P

In the present application, X+/−Y (with X and Y positive numbers) means an interval centered on value X, the interval ranging between the values X−Y and X+Y.

It can be noted that if two of the three opening angles of a pole are constrained by the equations, the third is also constrained by the construction of the rotor: in particular by the polar pitch (maximum opening angle), by the other opening angles (in particular the opening angle of the inner barrier is greater than the central opening angle, itself greater than the opening angle of the outer barrier), by the symmetry of the flow barriers within a pole. Thus, constraining two out of three angles by the equations is sufficient to obtain the desired effects in terms of reducing torque ripples and harmonics.

A major aspect of the invention is that rotor 1 comprises an alternation of primary magnetic poles 13 and secondary magnetic poles 14. Thus, the torque ripple, the counter-electromotive force harmonics and the acoustic noise are greatly reduced in relation to an electrical machine of the prior art, while maximizing the torque.

Indeed, asymmetrical flux barriers are thus created between two consecutive poles. The magnetic flux from the magnets thus cannot but pass through the solid parts between the perforations which allows reduction of the torque ripple, the counter-electromotive force harmonics and the acoustic noise.

According to an embodiment, the opening angles (θ1, θ2, θ3) of the primary magnetic poles 13 check at least two of the following three equations: θ1=(0.905+/0.02)×P, θ2=(0.683+/0.02)×P, θ3=(0.416+/0.02)×P. This embodiment allows optimizing the reduction of the torque ripple and the reduction of the harmonics.

According to an embodiment, the opening angles (θ1, θ2, θ3) of the secondary magnetic poles 14 satisfies at least two of the following three equations: θ1=(0.819+/0.02)×P, θ2=(0.601+/0.02)×P, θ3=(0.373+/0.02)×P. This embodiment allows optimizing the reduction of the torque ripple and the reduction of the harmonics.

Preferably, the opening angles (θ1, θ2, θ3) of the primary magnetic poles 13 satisfy the three equations set out below (i.e. either the equations according to the invention or the equations according to an embodiment). This embodiment allows optimizing the reduction of the torque ripple and the reduction of the harmonics.

Preferably, the opening angles (θ1, θ2, θ3) of the secondary magnetic poles 14 satisfy the three equations set out below (that is either the equations according to the invention or the equations according to an embodiment). This embodiment allows to optimize the reduction of the torque ripple and the reduction of the harmonics.

Thus, according to a preferred embodiment, the N primary magnetic poles 13 each have an internal flux barrier 11 having an opening angle θ1 substantially equal to (0.905+/−0.02)×P, a central flux barrier 10 having an opening angle θ2 substantially equal to (0.683+/−0.02)×P and an external flux barrier 9 having an opening angle θ3 substantially equal to (0.416+/−0.02)×P. The N secondary magnetic poles 14 each have an internal flux barrier 11 having an opening angle θ1 substantially equal to (0.819+/−0.02)×P, a central flux barrier 10 having an opening angle θ2 substantially equal to (0.601+/−0.02)×P and an external flux barrier 9 having an opening angle θ3 substantially equal to (0.373+/−0.02)×P. This preferred embodiment allows an optimal solution in terms of reduction of torque ripple and of reduction of the harmonics.

For the embodiment of FIGS. 1 and 2 where N=4, and therefore P=45°, the four primary magnetic poles 13 each have an internal flux barrier 11 with an opening angle θ1 substantially equal to 40.7°, a central flux barrier 10 with an opening angle θ2 substantially equal to 30.7° and an external flux barrier 9 with an opening angle θ3 substantially equal to 18.7°. The four secondary magnetic poles 14 each have an internal flux barrier 11 having an opening angle θ1 substantially equal to 36.9°, a central flux barrier 10 having an opening angle θ2 substantially equal to 27.1° and an external flux barrier 9 having an opening angle θ3 substantially equal to 16.8°.

FIG. 3 schematically illustrates, by way of non-limitative example, a portion of a rotor 1 with three pole pairs (N=3, therefore P=60°) according to an embodiment of the invention.

For the embodiment of FIG. 3 where N=3, the three primary magnetic poles 13 each have an internal flux barrier 11 having an opening angle θ1 substantially equal to 53.8°, a central flux barrier 10 having an opening angle θ2 substantially equal to 40.3° and an external flux barrier 9 having an opening angle θ3 substantially equal to 24.8°. The three secondary magnetic poles 14 each have an internal flux barrier 11 with an opening angle θ1 substantially equal to 49.0°, a central flux barrier 10 with an opening angle θ2 substantially equal to 35.6° and an external flux barrier 9 with an opening angle θ3 substantially equal to 22.5°. For this embodiment, the six opening angles (θ1, θ2, θ3 for the primary and secondary magnetic poles) are the preferred embodiment of the invention.

Reduction of the torque ripple, the counter-electromotive force harmonics and the acoustic noise is also obtained because the definition of the primary and secondary magnetic pole angles according to the invention enables a +1.2° mechanical phase shift angle in relation to an asymmetrical design of the electrical machine, and this asymmetrical design can for example (in the case of an eight-pole electrical machine) substantially correspond to the design described in the patent application bearing serial number FR-17/58,621. With this phase shift angle denoted by D, angles θi of the flux barriers can be determined using the following formula: θi=θiAA+2D, with i=1, 2 or 3 corresponding to the internal, central and external flux barriers, θiAA corresponding to the initial angle of the flux barrier.

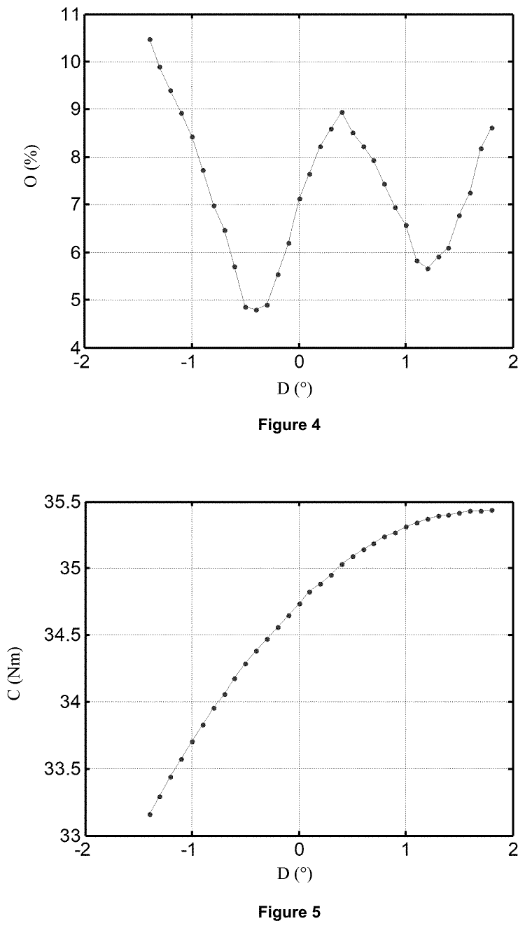

FIG. 4 illustrates the curve of torque ripple O in % as a function of phase shift angle D in degrees (°) for an electrical machine rotor with N asymmetrical pole pairs with each pole comprising three magnets and three flux barriers. It can be noted that this curve has two local minima, a first one around −0.3° and a second at +1.2°. Therefore, the angular configuration of the flux barriers allowing a +1.2° mechanical phase shift angle indeed enables reduction of the torque ripples.

FIG. 5 illustrates the curve of torque C in Nm as a function of phase shift angle D in degrees (°) for an electrical machine rotor with N asymmetrical pole pairs with each pole comprising three magnets and three flux barriers. It can be noted that the curve increases as a function of phase shift angle D. Therefore, the angular configuration of the flux barriers allowing a +1.2° mechanical phase shift angle enables a higher torque production than with a −0.3° phase shift angle, with a torque gain of about 0.8 Nm. Thus, a +1.2° mechanical phase shift angle provides a good compromise between reduction of the torque ripples and the torque produced.

Thus, the rotor according to the invention is suited for a synchro-reluctant electrical machine operating with a low-voltage continuous bus allowing a high rotational speed (above 15,000 rpm).

Table 1 gives, by way of non-limitative example, the values of angles θ1, θ2, and θ3 for different values of N according to the invention.

TABLE 1
Flux barriers angle as a function of the number of pole pairs

| | | N | | | |
|---|---|---|---|---|---|
| | | 3 | 4 | 5 | 6 |
| | | P | | | |
| | | 60° | 45° | 36° | 30° |
| Secondary | θ3 | 22.38° +/− 1.60° | 16.79° +/− 1.20° | 13.43° +/− 0.96° | 11.19° +/− 0.80° |
| magnetic | θ2 | 36.06° +/− 1.60° | 27.05° +/− 1.20° | 21.64° +/− 0.96° | 18.03° +/− 0.80° |
| pole 14 | θ1 | 49.14° +/− 1.60° | 36.86° +/− 1.20° | 29.48° +/− 0.96° | 24.57° +/− 0.80° |
| Primary | θ3 | 24.96° +/− 1.60° | 18.72° +/− 1.20° | 14.98° +/− 0.96° | 12.48° +/− 0.80° |
| magnetic | θ2 | 40.98° +/− 1.60° | 30.74° +/− 1.20° | 24.59° +/− 0.96° | 20.49° +/− 0.80° |
| pole 13 | θ1 | 54.30° +/− 1.60° | 40.73° +/− 1.20° | 32.58° +/− 0.96° | 27.15° +/− 0.80° |

Table 1 gives, by way of non-limitative example, the values of angles θ1, θ2, and θ3 for different values of N. for the preferred embodiment

TABLE 1
Flux barriers angle as a function of the number of pole pairs

| | | N | | | |
|---|---|---|---|---|---|
| | | 3 | 4 | 5 | 6 |
| | | P | | | |
| | | 60° | 45° | 36° | 30° |
| Secondary | θ3 | 22.38° +/− 1.20° | 16.79° +/− 0.90° | 13.43° +/− 0.72° | 11.19° +/− 0.60° |
| magnetic | θ2 | 36.06° +/− 1.20° | 27.05° +/− 0.90° | 21.64° +/− 0.72° | 18.03° +/− 0.60° |
| pole 14 | θ1 | 49.14° +/− 1.20° | 36.86° +/− 0.90° | 29.48° +/− 0.72° | 24.57° +/− 0.60° |
| Primary | θ3 | 24.96° +/− 1.20° | 18.72° +/− 0.90° | 14.98° +/− 0.72° | 12.48° +/− 0.60° |
| magnetic | θ2 | 40.98° +/− 1.20° | 30.74° +/− 0.90° | 24.59° +/− 0.72° | 20.49° +/− 0.60° |
| pole 13 | θ1 | 54.30° +/− 1.20° | 40.73° +/− 0.90° | 32.58° +/− 0.72° | 27.15° +/− 0.60° |

According to an implementation of the invention, rotor 1 can be 75 mm in length and constituent sheets 3 of rotor 1 can be 0.35-mm rolled metal sheets. However, these values are by no means limitative and any distance spectrum meeting the aforementioned angle values is possible.

As can be seen in FIG. 2 which schematically illustrates, by way of non-limitative example, a rotary electrical machine according to an embodiment of the invention (here a permanent magnet-assisted variable-reluctance synchronous machine), the electrical machine also comprises a stator 15 coaxially integrated in rotor 1.

Stator 15 comprises an annular ring 16 with an inner wall 17 whose inside diameter is designed to receive rotor 1 with a space necessary for providing an air gap 18. This ring comprises a multiplicity of slots (bores), of oblong section here, forming slots 19 for the armature windings.

More precisely, these bores extend axially all along stator 15 while being radially arranged on the ring and circumferentially at a distance from one another, by a distance D. The number of slots is predetermined as a function of the characteristics of the electrical machine and as a function of the number N of pole pairs. For the example illustrated in FIG. 2, where N=4, there are 48 slots.

According to an example embodiment, the outside diameter of the stator can range between 100 and 300 mm, and it is preferably around 140 mm, and the inside diameter can range between 50 and 200 mm, preferably around 95 mm. The length of air gap 18 of the electrical machine can range between 0.4 and 0.8 mm, preferably between 0.5 and 0.6 mm.

It is obvious that the invention is not limited to the recess shapes described above by way of example, and that it encompasses any variant embodiment.

1-13. (canceled)

14. A rotor for an electrical machine, rotor comprising:
a rotor body, including a stack of metal sheets arranged on a rotor shaft;
N pairs of magnetic poles, each magnetic pole including at least three magnets positioned in axial recesses, and
three asymmetrical flux barriers in each magnetic pole, including an external flux barrier, a central flux barrier and an internal flux barrier, each flux barrier comprising two inclined recesses positioned on either side of each axial recess, the two inclined recesses forming an opening angle that corresponds to the angle between two lines passing each through center C of rotor and through a midpoint positioned in the region of an outer face of the respective recesses of each flux barrier; and wherein
N primary magnetic poles each include an internal flux barrier with an opening angle θ₁, a central flux barrier with an opening angle θ₂ and an external flux barrier with an opening angle θ₃, the opening angles satisfying at least two of the following equations: θ1=(0.905+/0.027)×P, θ2=(0.683+/0.027)×P, θ3=(0.416+/0.027)×P;
N secondary magnetic poles each having an internal flux barrier with an opening angle θ₁, a central flux barrier with an opening angle θ₂ and an external flux barrier with an opening angle θ₃, the opening angles satisfying at least two of the following equations: θ1=(0.819+/0.027)×P, θ2=(0.601+/0.027)×P, θ3=(0.373+/0.027)×P, each secondary pole alternating with a primary pole; and
P being a pole pitch of the rotor defined in degrees by
$$P = \frac{360}{2 \times N} .$$

15. A rotor as claimed in claim 14, wherein the number N of magnetic pole pairs ranges between 2 and 9.

16. A rotor as claimed in claim 14, wherein the flux barriers are substantially V-shaped with a flat bottom.

17. A rotor as claimed in claim 14, wherein the opening angles (θ1, θ2, θ3) of the primary magnetic poles satisfy at least two of the following three equations: θ1=(0.905+/0.02)×P, θ2=(0.683+/0.02)×P, θ3=(0.416+/0.02)×P.

18. A rotor as claimed in claim 14, wherein the opening angles (θ1, θ2, θ3) of the secondary magnetic poles satisfy at least two of the following three equations: θ1=(0.819+/0.02)×P, θ2=(0.601+/0.02)×P, θ3=(0.373+/0.02)×P.

19. A rotor as claimed in claim 17, wherein the opening angles (θ1, θ2, θ3) of the primary magnetic poles satisfy the three equations.

20. A rotor as claimed in claim 18, wherein the opening angles (θ1, θ2, θ3) of the secondary magnetic poles satisfy the three equations.

21. An electrical machine comprising a stator and a rotor as claimed in claim 14, with the rotor being housed inside the stator.

22. An electrical machine as claimed in claim 21, wherein the stator comprises radial slots circumferentially arranged along the stator.

23. An electrical machine as claimed in claim 22, wherein slots extend axially along the stator.

24. An electrical machine as claimed in claim 21, wherein the stator has an outside diameter ranging between 100 and 300 mm, and an inside diameter ranging between 50 and 200 mm.

25. An electrical machine as claimed in claim 21, comprising an air gap having a length ranging between 0.4 and 0.8 mm.

26. An electrical machine as claimed in claim 21, wherein the electrical machine is a of synchro-reluctant electrical machine.

27. An electrical machine as claimed in claim 24 wherein the outside diameter is 140 mm and the inside diameter is 0.5 mm.

28. An electrical machine as claimed in claim 25 wherein the air gap is 0.5 mm.
